(19) United States
(12) Patent Application Publication
(10) Pub. No.: US 2026/0287082 A1
(43) Pub. Date: Sep. 24, 2026

(54) VALVE

(71) Applicant: FUJIKIN INCORPORATED, Osaka (JP)

(72) Inventors: Ryutaro TANNO, Osaka (JP); Yuya SUZUKI, Osaka (JP); Tomoki NAKADA, Osaka (JP); Yoshino FUJII, Osaka (JP)

(21) Appl. No.: 19/112,458

(22) PCT Filed: Nov. 20, 2023
(86) PCT No.: PCT/JP2023/041620

§ 371 Date: Jun. 5, 2026

(30) Foreign Application Priority Data
Nov. 30, 2022 (JP) 2022-192441

(51) Int. Cl. F16K 31/165; F16K 7/12; F16K 37/00

(52) U.S. Cl. CPC F16K 31/165; F16K 7/12; F16K 37/0041; F16K 37/005

(57) ABSTRACT

A change in operation time due to a change or the like of a valve actuator with the passage of time is monitored by a valve alone.

A valve V includes: a manipulation pressure chamber 52 into which a manipulation pressure for opening and closing the valve V is introduced; a manipulation pressure sensor D that detects a change in manipulation pressure in the manipulation pressure chamber 52; and a magnetic sensor M that detects an internal operation of the valve V corresponding to the change in manipulation pressure. A time from a predetermined time point at which the manipulation pressure changes to a predetermined time point at which an operation corresponding to the change of the manipulation pressure is detected by the magnetic sensor M, is monitored as an operation time of the valve V based on data detected by the magnetic sensor M and the manipulation pressure sensor D.

### TECHNICAL FIELD

The present invention relates to a technology for monitoring an operation time of a valve.

### BACKGROUND ART

In semiconductor processes, there is a demand for a finer thin film in film formation processing of forming a thin film on a surface of a semiconductor wafer, and in recent years, film formation methods referred to as atomic layer deposition (ALD) for forming a thin film having a thickness at an atomic level or a molecular level have been used.

In such semiconductor processes, it is important to accurately supply, to a processing chamber, a process gas at a flow rate instructed by a user, and more frequent opening and closing operations than ever before are required. However, a load due to such more frequent opening and closing operations may result in fluid leakage. Therefore, technologies such as a system in which a valve equipped with a sensor capable of easily detecting a defect such as exposure of a fluid or a failure in a fluid control device diagnoses whether a failure has occurred have been disclosed.

In this regard, Patent Literature 1 discloses a method for controlling a gate valve that is a pneumatic gate valve including a valve body which is opened and closed by pressurized air supplied on the basis of an opening/closing command from a host device, the method including detecting a pressure value of the pressurized air by a pressure sensor, detecting, by a vibration sensor, a vibration condition generated when the valve body is opened and closed by the pressurized air, sending an opening/closing signal to the host device by detecting that the valve body has reached an open position or a closing position, by a position sensor, and measuring an opening/closing time from when the host device issues an opening/closing command to when the host device receives the opening/closing signal, and notifying the host device of the pressure value of the pressurized air, the opening/closing time of the valve body, and the vibration condition.

Also, Patent Literature 2 discloses a shut-off valve control system equipped with a shut-off valve, and control means for controlling an opening degree of the shut-off valve, the control means having an air cylinder that rotationally controls a valve shaft of the shut-off valve, and an electromagnetic valve that supplies and exhausts air from an air supply source to a cylinder of the air cylinder, the shut-off valve control system including a pressure sensor that detects an internal pressure of the cylinder, determination means for determining normality/abnormality of the system on the basis of pressure characteristics of the internal pressure of the cylinder which is actually measured by the pressure sensor in a case where air has been supplied from the air supply source to the cylinder of the air cylinder under control of the control means, and storage means for storing, in advance, the pressure characteristics of the internal pressure of the cylinder and pressure characteristics of a failure prediction boundary during an initial normal operation of the system, in which the determination means determines that the system is normal in a case where the actually measured pressure characteristics falls within a range between the pressure characteristics during the normal operation and the pressure characteristic of the failure prediction boundary, and determines that the system is abnormal in a case where the actually measured pressure characteristic is outside the range between the pressure characteristic during the normal operation and the pressure characteristic of the failure prediction boundary.

### CITATION LIST

### Patent Literature

### Patent Literature 1: JP 2020-176689 A

### Patent Literature 2: JP 2012-052652 A

### SUMMARY OF INVENTION

### Technical Problem

However, technologies for detecting a failure or the like inside an actuator by observing a stroke volume of a piston or a stem or detecting whether a valve is in an open state or a closed state, by a position sensor, are disclosed, but means for checking an operation time of a valve due to a change of a valve actuator with the passage of time, such as wear of an O-ring has not been disclosed until the present time.

Here, the fact that a response speed of the valve has become faster means that a flow rate of a process gas has increased from a designated rate since a time during which the valve is open has increased. Meanwhile, the fact that the response speed of the valve has become slower means that the flow rate of the process gas has decreased from the designated rate since the time during which the valve is open has shortened. Such conditions result in a big problem in a situation in which a gas flow rate needs to be accurately controlled as described above.

In this respect, an object of the present invention is to monitor, by a valve alone, a change in operation time due to a change or the like of a valve actuator with the passage of time.

### Solution to Problem

In order to achieve the above object, a valve according to the present invention includes a manipulation pressure chamber into which a manipulation pressure for opening and closing the valve is introduced; a manipulation pressure sensor that detects a change in manipulation pressure in the manipulation pressure chamber; and a position sensor that detects an internal operation of the valve corresponding to the change in manipulation pressure, in which a time from a predetermined time point at which the manipulation pressure changes to a predetermined time point at which an operation corresponding to the manipulation pressure is detected by the position sensor, is monitored as an operation time of the valve based on data detected by the position sensor and the manipulation pressure sensor.

The valve may further include a manipulation pressure adjusting mechanism that adjusts a flow channel area of a manipulation pressure introduction channel communicating with the manipulation pressure chamber based on a difference between the operation time and a predetermined reference value in a case where a change in the operation time is detected.

The valve may further include: an atmosphere chamber that communicates with outside and suctions and exhausts air depending on introduction of a manipulation pressure into the manipulation pressure chamber and discharge of the manipulation pressure from the manipulation pressure chamber; and an exhaust pressure adjusting mechanism that adjusts a flow channel area of an air discharge channel allowing communication from the atmosphere chamber to the outside based on a difference between the operation time and a predetermined reference value in a case where a change in the operation time is detected.

### Advantageous Effects of Invention

According to the present invention, a change in operation time due to a change or the like of a valve actuator with the passage of time is monitored by the valve alone.

### BRIEF DESCRIPTION OF DRAWINGS

FIG. 1 is an external perspective view illustrating a valve according to an embodiment of the present invention.

FIG. 2 is a longitudinal sectional view illustrating an internal structure of the valve according to the present embodiment, and is a view illustrating a valve open state.

FIG. 3 is a partially enlarged longitudinal sectional view illustrating the internal structure of the valve according to the present embodiment, and illustrates (a) the valve open state and (b) a valve closed state.

FIG. 4 is a perspective view illustrating a bonnet included in the valve according to the present embodiment.

FIG. 5 is a partially enlarged cross-sectional view illustrating an actuator unit included in the valve according to the present embodiment.

FIG. 6 is a functional block diagram illustrating functions of the valve according to the present embodiment.

FIG. 7 is a functional block diagram illustrating functions of a valve according to a modification example of the present embodiment and functions of a server configured to be able to communicate with the valve.

FIG. 8 is a graph illustrating a relationship between a manipulation pressure and a position sensor output which is a calculation basis of an operation time of the valve according to the present embodiment.

FIG. 9 is a processing flowchart illustrating a flow of processing executed by the valve according to the present embodiment.

### DESCRIPTION OF EMBODIMENTS

Hereinafter, a valve according to an embodiment of the present invention will be described with reference to the drawings.

In the following description, directions of members and the like may be referred to as up, down, left, and right depending on directions in the drawings for convenience, but these do not limit directions of members and the like at the time of implementation or use of the present invention. Also, regarding reference numerals assigned to names of respective parts, the same reference numerals are assigned to parts having the same functions, and the parts are distinguished by respective numbers following hyphens when individually referred to.

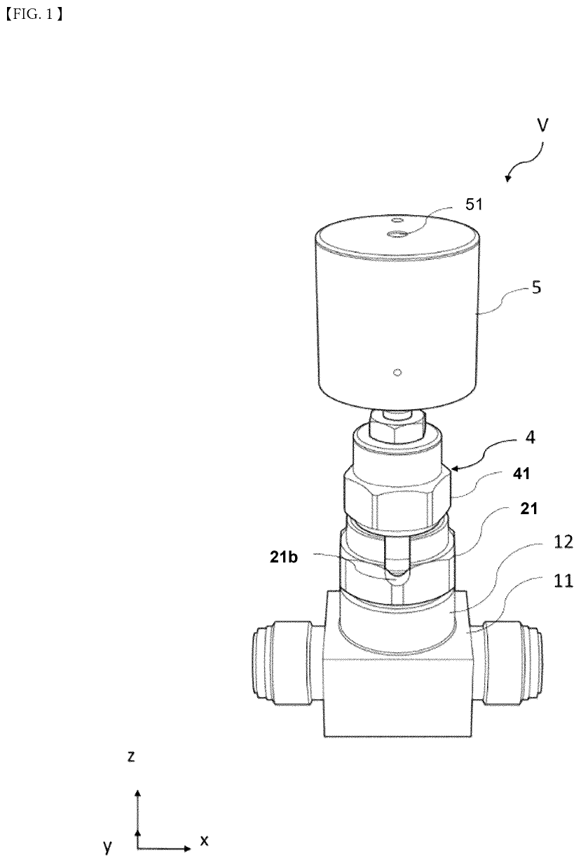

As illustrated in FIG. 1, a valve V according to the present embodiment is an air-operated direct diaphragm valve that includes a built-in sensor detecting an internal operation of the valve V and executes communication with another terminal or the like.

The terminal mentioned here includes an instrument or a device such as another fluid control device or flow rate control device in addition to a so-called computer such as a server.

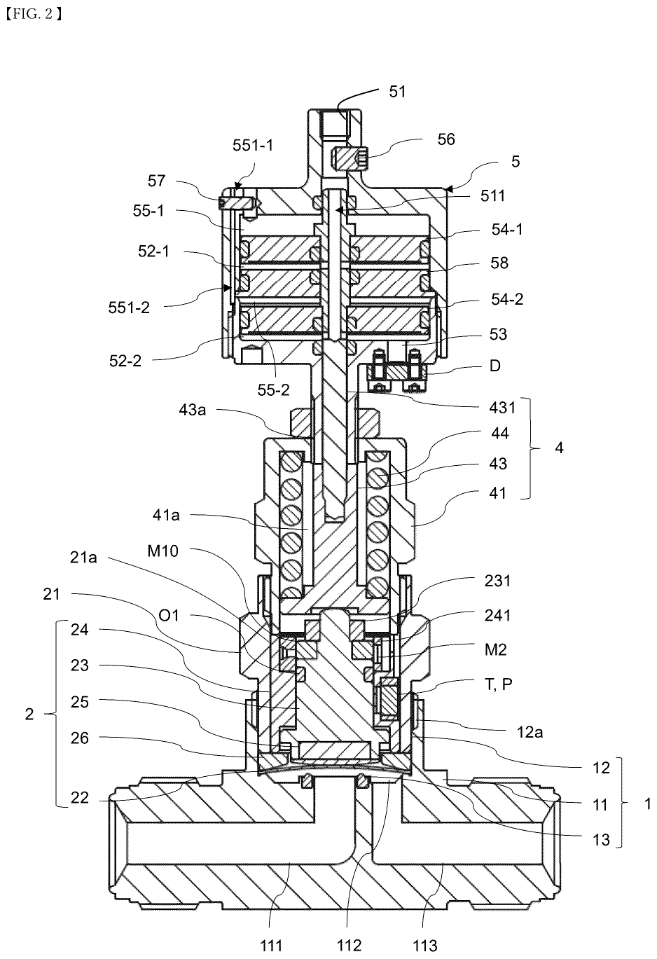

The valve V according to the present embodiment is an instrument capable of acquiring data related to the internal operation, and includes a valve body portion 1, a first bonnet portion 2, a second bonnet portion 4, and an actuator unit 5 as illustrated in FIGS. 1 and 2.

### Valve Body Portion 1

As illustrated in FIGS. 1 and 2, the valve body portion 1 includes a base portion 11 in which a flow channel of a process gas is formed, a substantially cylinder-shaped cylindrical portion 12 provided on the base portion 11, and an annular seat 13.

The base portion 11 has a rectangular shape in plan view, and is a portion installed on a substrate or a manifold block in a case where a plurality of valves V are unitized to form a fluid control device.

The cylindrical portion 12 has a hollow shape with an end surface on a side where a part of the first bonnet portion 2 is disposed is open, and a hollow interior forms a recess 12a in which the part of the first bonnet portion 2 is accommodated. Below the recess 12a and in the base portion 11, an inflow channel 111 into which a fluid flows, an outflow channel 113 from which a fluid flows out, and a valve chamber 112 communicating with the inflow channel 111 and the outflow channel 113 are formed. The inflow channel 111, the outflow channel 113, and the valve chamber 112 integrally constitute a flow channel through which a fluid circulates.

The annular seat 13 is provided at a circumferential edge of the inflow channel 111. A diaphragm 22 is provided on the seat 13 to abut or be separated from the seat 13, thereby allowing a fluid to circulate in the inflow channel 111 and the outflow channel 113 or blocking circulation of the fluid.

### First Bonnet Portion 1

As illustrated in FIG. 2, the first bonnet portion 2 is disposed on the cylindrical portion 12 of the valve body portion 1.

The first bonnet portion 2 includes a first bonnet body 21, the diaphragm 22, a disk 23, a sensor bonnet 24, a diaphragm presser 25, and a presser adapter 26.

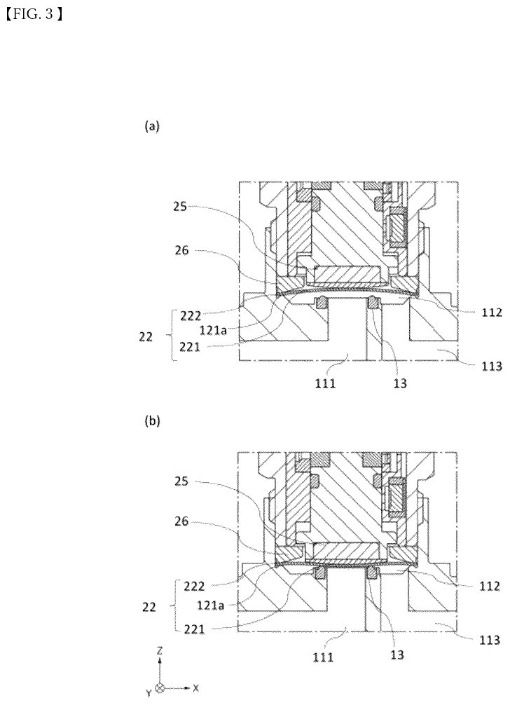

As illustrated in FIG. 3 (a) and 3 (b), the diaphragm 22 is a spherical shell-shaped member made of metal such as stainless steel or a Ni-Co-based alloy or a fluorine-based resin and having a central portion 221 bulging in a convex shape, and isolates the inflow channel 111 and the outflow channel 113 from a space in which the first bonnet portion 2 operates.

The first bonnet body 21 is interposed between the cylindrical portion 12 and the second bonnet body 41.

The first bonnet body 21 has a substantially cylindrical shape and has a through-hole 21a allowing penetration of the sensor bonnet 24 is provided at a central portion of the first bonnet body in a length direction thereof so that a lower end portion of the first bonnet body 21 abuts the presser adapter 26 and presses the presser adapter 26 downward.

The first bonnet body 21 includes a slit 21b that has one open end on a side opposite to the base portion 11 and penetrates the first bonnet body from the outer side toward the through-hole 21a.

When a drive fluid as a manipulation pressure is supplied to the diaphragm 22, and the diaphragm 22 is released from the pressing of the diaphragm presser 25, the central portion 221 is displaced in a direction away from the seat 13 by its own restoring force and a pressure in the flow channel and is separated from the seat 13. As a result, the valve chamber 112 is open, and the inflow channel 111 and the outflow channel 113 communicate with each other. Meanwhile, when the drive fluid as the manipulation pressure is discharged, and the diaphragm 22 is pressed by the diaphragm presser 25, the central portion 221 of the diaphragm 22 is displaced in a direction in which the central portion abuts the seat 13 and abuts the seat 13. As a result, the valve chamber 112 is blocked, and the inflow channel 111 and the outflow channel 113 are blocked.

That is, the central portion 221 of the diaphragm 22 is a movable portion that is displaced by the supply of the drive fluid, and a circumferential edge portion 222 is a non-movable portion that is not displaced even when the drive fluid is supplied.

The circumferential edge portion 222 of the diaphragm 22 abuts the presser adapter 26 to be described below, and is sandwiched between the presser adapter 26 and a protrusion 121a (see FIG. 3 (a) and 3 (b)) provided in an upper orientation inside the recess 12a of the valve body portion 1.

The disk 23 is provided on an upper side of the diaphragm 22, is supported by the sensor bonnet 24 to be vertically movable, and is coupled to a sliding stem 43 to press the central portion of the diaphragm 22.

An O-ring 01 is attached on an outer circumferential surface of the disk 23, and the O-ring 01 seals an interface between the disk 23 and an inner circumferential surface of the sensor bonnet 24.

An upper portion of the disk 23 has a small outer diameter and is inserted into a magnet holder M10. The magnet holder M10 is a substantially ring-shaped member having a cutout portion, and a magnet is attached to the cutout portion. The magnet constitutes a magnetic sensor M, which will be described below, together with a magnetic body M2 attached to a sensor holder 241 embedded in a recess of the sensor bonnet 24. Also, the magnet holder M10 has a recess in an outer circumference, and a positioning member such as a bolt penetrating the sensor holder 241 presses the recess, thereby preventing a positional shift of the magnet holder M10. A locknut 231 is fitted on an upper end portion of the disk 23 and above the magnet holder M10 to prevent the magnet holder M10 from escaping.

The diaphragm presser 25 is connected to a lower end of the disk 23. A lower surface side of the diaphragm presser 25 is a convex surface bulging downward, and the lower surface side thereof abuts the central portion 221 of the diaphragm 22 and is coupled to the sliding stem 43 to press the diaphragm 22.

As illustrated in FIG. 3 (a) and 3 (b), a lower end of the diaphragm presser 25 abuts the central portion 221 of the diaphragm 22 both when the valve is open and when the valve is closed. That is, a contact area between the diaphragm presser 25 and the diaphragm 22 is the same area both when the valve is open and when the valve is closed. According to this configuration, the diaphragm 22 has a constant heat transmission area both when the valve is open and when the valve is closed, and accurate temperature measurement can be performed by a temperature sensor T to be described below.

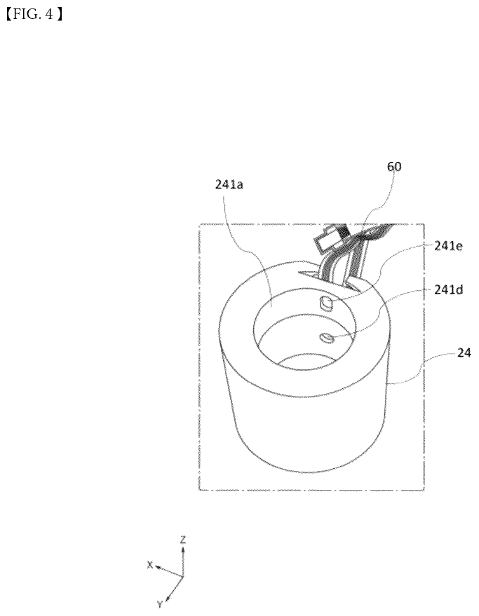

As illustrated in FIGS. 2 and 4, the sensor bonnet 24 has a substantially cylindrical shape, covers the valve chamber 112, and is accommodated in the first bonnet body 21.

An insertion hole 241a into which the disk 23 is inserted is formed at a central portion in the sensor bonnet 24.

Also, the sensor bonnet 24 has a communication hole 241d communicating with a pressure sensor P and the temperature sensor T. The pressure sensor P and the temperature sensor T provided via the communication hole 241d can measure a pressure and a temperature in a space defined by the diaphragm 22, the disk 23, and the sensor bonnet 24.

In the present embodiment, the temperature sensor T is provided inside the sensor bonnet 24, but the temperature sensor T only needs to be provided on an inner side of the valve body portion 1, and in particular, at least a temperature detection portion of the temperature sensor T only needs to be placed on the inner side of the valve body portion 1. According to this configuration, it is possible to accurately measure the temperature in the valve V only by installing the valve V without additionally performing installation work or the like of a temperature sensor.

Also, a flexible cable 60 connected to the pressure sensor P, the temperature sensor T, and the magnetic sensor M inside the sensor bonnet 24 extends outward from a side surface of the sensor bonnet 24.

The magnetic body M2 held by the sensor holder 241 is attached to the inner circumferential surface of the sensor bonnet 24, and constitutes the magnetic sensor M, which will be described below, together with the magnet attached to the disk 23.

The sensor bonnet 24 is made of an aluminum material. Since the aluminum material has the thermal conductivity higher than that of stainless steel (SUS) or the like, a fluid temperature can be more accurately transmitted to the temperature sensor T inside the sensor bonnet 24. Also, since the sensor bonnet 24 made of an aluminum material is not magnetized, an effect of the magnetic sensor M on the temperature sensor T and the pressure sensor P can be reduced.

The presser adapter 26 abuts the circumferential edge portion 222 of the diaphragm 22, and sandwiches the diaphragm 22 in cooperation with the protrusion 121a in the recess 12a of the valve body portion 1. Also, the circumferential edge portion 222 is pressed from above to prevent the fluid flowing in the inflow channel 111 and the outflow channel 113 from leaking outside from the vicinity of the circumferential edge portion 222.

The presser adapter 26 is not brought into contact with the movable portion, in other words, the central portion 221, of the diaphragm 22 both when the diaphragm 22 is opened and when the diaphragm 22 is closed. Also, a contact area between the presser adapter 26 and the diaphragm 22 is the same both when the valve is open and when the valve is closed. According to this configuration, the diaphragm 22 has a constant heat transmission area both when the valve is open and when the valve is closed. Further, since conductive heat from the diaphragm 22 becomes constant, it is possible to accurately measure the temperature by the temperature sensor T to be described below regardless of the open/closed state of the valve.

### Second Bonnet Portion 4

The second bonnet portion 4 is disposed on the first bonnet portion 2.

As illustrated in FIG. 2, the second bonnet portion 4 includes a second bonnet body 41, the stem 43, and a spring 44.

The second bonnet body 41 is interposed between the stem 43 and the sensor bonnet 24.

The second bonnet body 41 has a substantially columnar shape and has, at a central portion, an insertion hole 41a in a length direction thereof into which the stem 43 and the disk 23 are inserted. As illustrated in FIGS. 2 and 3, the stem 43 and the disk 23 about each other in the insertion hole 41a, and when the stem 43 is displaced downward, the disk 23 is pressed downward. Consequently, the diaphragm 22 is seated on the seat 13.

The stem 43 moves up and down in response to supply and stop of the manipulation pressure, and causes the diaphragm 22 to abut or be separated from the seat 13 via the disk 23 and the diaphragm presser 25.

A rod 431 is connected to an upper portion of the stem 43. The rod 431 projects from an upper portion of the second bonnet portion 4 and is inserted into the actuator unit 5. Since the rod 431 is connected to the stem 43 to move up and down integrally, the rod 431 may be used synonymously with the stem 43.

The stem 43 has a large-diameter portion at a lower portion, and receives a bias force of the spring 44 on an upper surface side of the large-diameter portion.

The spring 44 is wound around an outer circumferential surface of the stem 43, and abuts an upper surface of the large-diameter portion formed at the lower portion of the stem 43 to bias the stem 43 downward, that is, in a direction in which the diaphragm 22 is pressed.

### Actuator Unit 5

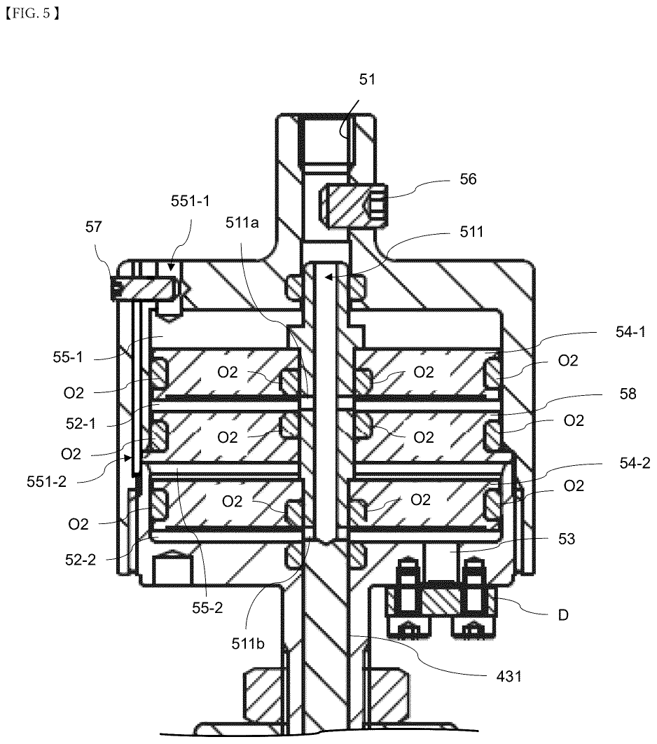

As illustrated in FIGS. 2 and 5, the actuator unit 5 is a bottomed cylindrical member having a supply port 51 to which a supply source of the drive fluid is connected. The supply port 51 is an opening portion communicating with a manipulation pressure introduction channel 511 formed above the rod 431, and the manipulation pressure introduction channel 511 branches in a radial direction from an axial direction of the rod 431 and communicates with a manipulation pressure chamber 52.

An inside of the actuator unit 5 is separated into upper and lower spaces by a partition wall member 58 slidably penetrating the rod 431, and a piston 54-1 that engages with the rod 431 is provided in the upper space to be slidable in a vertical direction. Also, a piston 54-2 that engages with the rod 431 is provided in the lower space to be slidable in the vertical direction.

The piston 54-1 partitions the upper space of the actuator unit 5 into a manipulation pressure chamber 52-1 and an atmosphere chamber 55-1, and the piston 54-2 partitions the lower space of the actuator unit 5 into a manipulation pressure chamber 52-2 and an atmosphere chamber 55-2.

The manipulation pressure chamber 52-1 communicates with the manipulation pressure introduction channel 511 formed at a central portion of the rod 431 via a branch channel 511a, and the manipulation pressure chamber 52-2 communicates with the drive pressure introduction channel 511 formed at the central portion of the rod 431 via a branch channel 511b. An opening of the rod 431 on an upper end side of the drive pressure introduction channel 511 communicates with the supply port 51 formed in the central portion of the actuator unit 5 on the upper side. The drive fluid supplied through the drive pressure introduction channel 511 is supplied to the manipulation pressure chamber 52.

The atmosphere chamber 55-1 communicates with the atmosphere through an air discharge channel 551-1 formed in the actuator unit 5. The atmosphere chamber 55-2 also communicates with the atmosphere through an air discharge channel 551-2 formed in the actuator unit 5. The atmosphere chambers 55-1 and 55-2 suction and discharge air depending on displacement of the piston 54 that operates depending on introduction of the manipulation pressure into the manipulation pressure chamber 52 or discharge of the manipulation pressure from the manipulation pressure chamber 52.

O-rings 02 are provided between the pistons 54 and inner walls of the actuator unit 5 and between the rod 431 and the pistons 54 in order to ensure airtightness of the manipulation pressure chamber 52. The O-ring 02 slides up and down as the piston 54 moves up and down.

Here, a valve opening/closing operation depending on supply and stop of the manipulation pressure will be described. When the drive fluid is supplied from a three-way valve connected to the supply port 51 via an introduction pipe (not illustrated), the drive fluid is introduced into the manipulation pressure chamber 52 via the manipulation pressure introduction channel 511. Accordingly, when the piston 54 is lifted, the stem 43 and the sensor bonnet 24 are pushed upward against the bias force of the spring 44, and the air in the atmosphere chamber 55 is discharged outside via the air discharge channel 551. Consequently, the diaphragm 22 is separated from the seat 13 and opened, and the fluid circulates.

Meanwhile, when the supply of the drive fluid is blocked in the three-way valve, and the supply port 51 and the manipulation pressure introduction channel 511 are open to the atmosphere via the introduction pipe (not illustrated), the manipulation pressure in the manipulation pressure chamber 52 is discharged outside via the manipulation pressure introduction channel 511. When a pressure in the manipulation pressure chamber 52 is reduced accordingly, the piston 54 is lowered, and the stem 43 and the sensor bonnet 24 are pushed downward according to the bias force of the spring 44. Also, external air flows into the atmosphere chamber 55 through the air discharge channel 551. Consequently, the diaphragm 22 abuts the seat 13 and is closed, and the flow of the fluid is blocked.

The actuator unit 5 includes a manipulation pressure adjusting mechanism 56 capable of adjusting a pressure increase speed of the manipulation pressure in the manipulation pressure chamber 52 depending on a change in operation time, and an exhaust pressure adjusting mechanism 57 capable of adjusting an exhaust speed of the air in the atmosphere chamber 55 depending on a change in operation time.

The manipulation pressure adjusting mechanism 56 is provided in the vicinity of the supply port 51, that is, at a position on the manipulation pressure introduction channel 511, and is provided to adjustably limit the amount of the drive fluid introduced into the manipulation pressure chamber 52 or the drive fluid discharged from the manipulation pressure chamber 52.

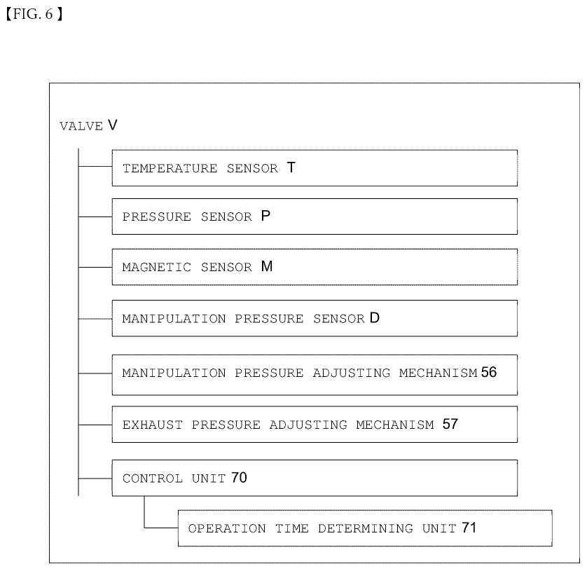

When a change in operation time of the valve V is detected, the manipulation pressure adjusting mechanism 56 performs adjusting by blocking or opening the manipulation pressure introduction channel under control of a control unit 70 (see FIG. 6) so that a flow channel area of the manipulation pressure introduction channel 511 connected from the supply port 51 to the manipulation pressure chamber 52 becomes a predetermined flow channel area. In a specific example, the manipulation pressure adjusting mechanism 56 includes a screw hole formed to cross the manipulation pressure introduction channel 511 and a screw member screwed into the screw hole, and the flow channel area can be adjusted to become any areas depending on an amount of screwing of the screw member into the screw hole.

Regardless of the present embodiment, the manipulation pressure adjusting mechanism 56 can employ another structure as long as the flow channel area can be adjusted to any areas. Also, this control may be performed by a system or may be performed manually.

The manipulation pressure adjusting mechanism 56 may be provided in the supply port 51 to block or open an opening area of the supply port 51 instead of the manipulation pressure introduction channel 511. Also, the manipulation pressure introduction channel 511 branches in the radial direction from the axial direction of the rod 431 and communicates with the manipulation pressure chamber 52, but in the present embodiment, the manipulation pressure adjusting mechanism 56 is provided at a position close to the supply port 51 in front of a position at which the manipulation pressure introduction channel 511 branches in the radial direction.

The exhaust pressure adjusting mechanism 57 is provided at a position on the air discharge channels 551-1 and 551-2, and is provided to adjustably limit an airflow volume of the air discharged outside from the atmosphere chambers 55-1 and 55-2 through the air discharge channels 551-1 and 551-2 or the airflow volume of the air suctioned into the atmosphere chambers 55-1 and 55-2 through the air discharge channels 551-1 and 551-2.

When a change in operation time of the valve V is detected, the exhaust pressure adjusting mechanism 57 performs adjusting by blocking or opening the air discharge channel under control of the control unit 70 so that the flow channel area of the air discharge channel 551 communicating with the atmosphere chamber 55 becomes a predetermined flow channel area. Specifically, for example, the exhaust pressure adjusting mechanism 57 includes a screw hole formed to cross the air discharge channels 551-1 and 551-2 and a screw member screwed into the screw hole. Thus, the flow channel area can be adjusted to any areas depending on an amount of screwing of the screw member into the screw hole. That is, the screw member has pin portions and a groove portion in which no threads are formed at a distal end portion and a middle portion, respectively, and the pin portion and the groove portion appear in the air discharge channels 551-1 and 551-2 to open the flow channel or are detached from the air discharge channels 551-1 and 551-2 to block the flow channel depending on insertion and withdrawal of the screw member into the screw hole.

Regardless of the present embodiment, the exhaust pressure adjusting mechanism 57 may employ another structure as long as the airflow volume can be adjusted to any volumes, and the airflow volume may be adjusted by the exhaust pressure adjusting mechanism 57 in which the air discharge channels 551-1 and 551-2 are separately provided. Also, this control may be performed by a system or may be performed manually.

### Sensor

The valve V includes the pressure sensor P, the temperature sensor T, the magnetic sensor M, and a manipulation pressure sensor D as sensors for detecting an operation in the instrument. Of the sensors, the pressure sensor P, the temperature sensor T, and the magnetic sensor M are provided inside the sensor bonnet 24, face the insertion hole 241a of the sensor bonnet 24 via a communication hole 241d of the sensor bonnet 24 illustrated in FIG. 4, and communicate with a space defined by the diaphragm 22, the disk 23, and the sensor bonnet 24. Consequently, the pressure sensor P can detect a pressure in the space.

A seal member such as a packing is provided at a position where the pressure sensor P communicates with the communication hole 241d to ensure an airtight state.

The temperature sensor T measures a temperature of the space defined by the diaphragm 22, the disk 23, and the sensor bonnet 24. According to the valve V having the temperature sensor I, a temperature of the fluid can be measured while control of the fluid is performed.

The magnetic body M2 is attached to a through-hole 241e of the sensor bonnet 24, and the magnetic body M2 constitutes, together with the magnet attached to the disk 23, the magnetic sensor M, and serves as a position sensor that detects a position of the stem 43, as an internal operation of the valve V.

The magnetic sensor M can detect the opening/closing operation of the valve and a movement amount of the stem 43 as follows. That is, while the magnet held by the magnet holder M10 slides depending on the vertical movement of the disk 23, the magnetic body M2 is fixed, together with the sensor bonnet 24, in the first bonnet portion 2. As a result, based on a change in magnetic field generated between the magnet held by the magnet holder M10 that moves up and down depending on the up and down movement of the disk 23 and the magnetic body M2 whose position is fixed, it is possible to detect operations of the disk 23 and the diaphragm presser 25, eventually, the opening and closing operation of the valve, and the movement amount of the stem 43.

Although the magnetic sensor M is used in the present embodiment, the present invention is not limited thereto, and other types of sensors such as an optical position sensor can be used in other embodiments.

The manipulation pressure sensor D is provided in the actuator unit 5, and detects the manipulation pressure in the manipulation pressure chamber 52 via the communication hole 53 communicating with the manipulation pressure chamber 52.

One end of the flexible cable 60 for communication is connected to each of the pressure sensor P, the temperature sensor T, the magnetic sensor M, and the manipulation pressure sensor D (specifically, the magnetic sensor M is connected to the magnetic body M2), and the other end of the flexible cable 60 is connected to a circuit board provided on the outer side of the valve V. Further, the circuit board includes a substantially rectangular connector for external terminal connection, thereby enabling data measured by the pressure sensor P, the temperature sensor T, and the magnetic sensor M to be extracted. The type and shape of connector can be appropriately designed in accordance with various standards. The data detected by each sensor may be transmitted to a predetermined instrument or server via wireless communication.

According to the valve V having such a configuration, data detected by the pressure sensor P, the temperature sensor T, the magnetic sensor M, and the manipulation pressure sensor D can be output to the outside. Thus, such data can become information for finding an opening/closing operation of the valve and an operation time thereof, leakage due to breakage or the like of the diaphragm 22, aging deterioration or an individual difference of the valve V, or the like.

### Control Unit

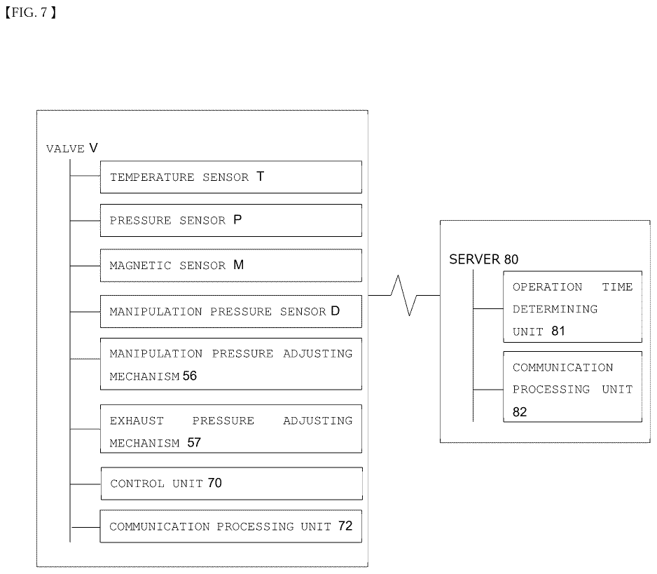

As illustrated in FIG. 6, the valve V according to the present embodiment includes the control unit 70 that processes data detected by the sensors. The control unit 70 includes an operation time determining unit 71 as a functional block. As in another example illustrated in FIG. 7, the valve V may include a communication processing unit 72 and communicate with a communication processing unit 82 of a server 80. In the example illustrated in FIG. 6, the valve V and the server 80 are connected via a network. Thus, the server 80 may include an operation time determining unit 81 corresponding to the operation time determining unit 71 and a communication processing unit 82.

The operation time determining unit 71 calculates an operation time of the valve V based on data detected by the magnetic sensor M and the manipulation pressure sensor D, and monitors the operation time. Further, the calculated operation time can be compared with a predetermined reference value to determine whether or not the operation time is appropriate.

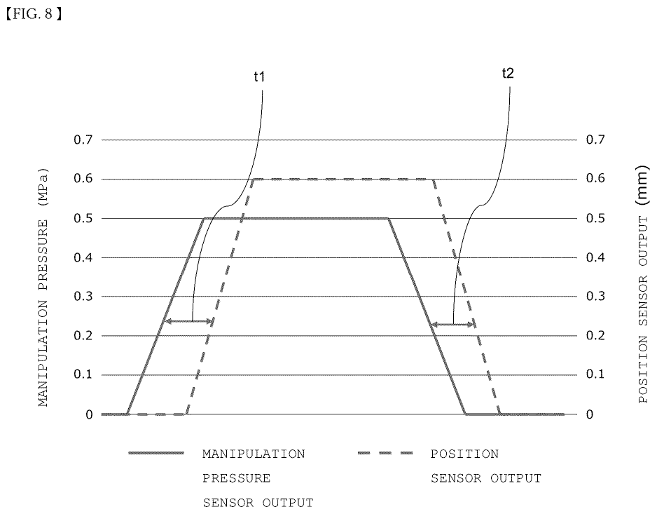

More specific determination processing will be described with reference to FIG. 8. FIG. 8 is a graph illustrating a calculation image of the operation time, in which the horizontal axis represents a time change, and the vertical axis represents an output value of the manipulation pressure sensor D and an output value of the position sensor (magnetic sensor M). According to this graph, it can be found that, when the manipulation pressure is introduced into the manipulation pressure chamber 52 at the time of a valve opening operation, the stem 43 is lifted after a certain time lag (response time), and the position sensor (the magnetic sensor M) shows a predetermined output value. Also, it is found that, when the manipulation pressure in the manipulation pressure chamber 52 is discharged at the time of a valve closing operation, the stem 43 is lowered after a certain time lag (response time), and the position sensor (the magnetic sensor M) shows a predetermined output value. This time lag, that is, a time from a predetermined time point at which the manipulation pressure changes to a predetermined time point at which an operation corresponding thereto is detected by the position sensor (the magnetic sensor M), corresponds to an operation time of the opening/closing operation of the valve V. A time t1 in FIG. 8 indicates an operation time at the time of the valve opening operation, and a time t2 indicates an operation time at the time of the valve closing operation.

A manipulation pressure serving as a starting point of the operation time and a position sensor output serving as an end point are any predetermined values, and the axes values illustrated on the left and right of FIG. 8 are merely examples.

Also, the reference value may be a value stored in advance in an appropriate storage unit, or may be a value saved by measuring an operation time in an initial state at the start of use of the valve V. Also, the reference value may be a design value of the operation time of the valve V.

Here, the operation time tends to increase mainly due to aging such as wear of the O-ring 02. When the operation time has become faster, timings of the valve opening operation and the valve closing operation in response to a control signal of the valve V change from the initial state, and a flow rate of a process gas does not become a designated amount. That is, as the operation time when the valve is open has become faster, the time during which the valve is open and the fluid circulates, that is, a valve opening time is lengthened, and the flow rate of the process gas is increased more than the designated amount. Also, as the operation time when the valve is closed has become faster, the valve opening time is shortened, and the flow rate of the process gas is reduced to be smaller than the designated amount.

On the other hand, the operation time determining unit 71 compares the operation time of each of the valve opening operation and the valve closing operation calculated on the basis of a change in the manipulation pressure and a change in the position sensor output with the reference value of the appropriate operation time in a predetermined table, determines that the valve is suitable when the operation time falls within an allowable range, and determines that the valve is in an inappropriate state when the operation time exceeds the allowable range.

Thus, in a case where the operation time determining unit 71 determines that the operation time of the valve V is inappropriate, or in a case where the operation time needs to be adjusted to any time after the operation time is confirmed, the control unit 70 can control the manipulation pressure adjusting mechanism 56 or the exhaust pressure adjusting mechanism 57 to adjust the operation time. Consequently, the time during which the valve V is in the valve open state is adjusted, and the amount of process gas which is the designated amount can be circulated.

An adjustment target time amount is calculated based on a difference between the reference value and the operation time from the change in manipulation pressure to the valve opening operation or the valve closing operation detected based on the change in output of the magnetic sensor M.

### Processing Flow

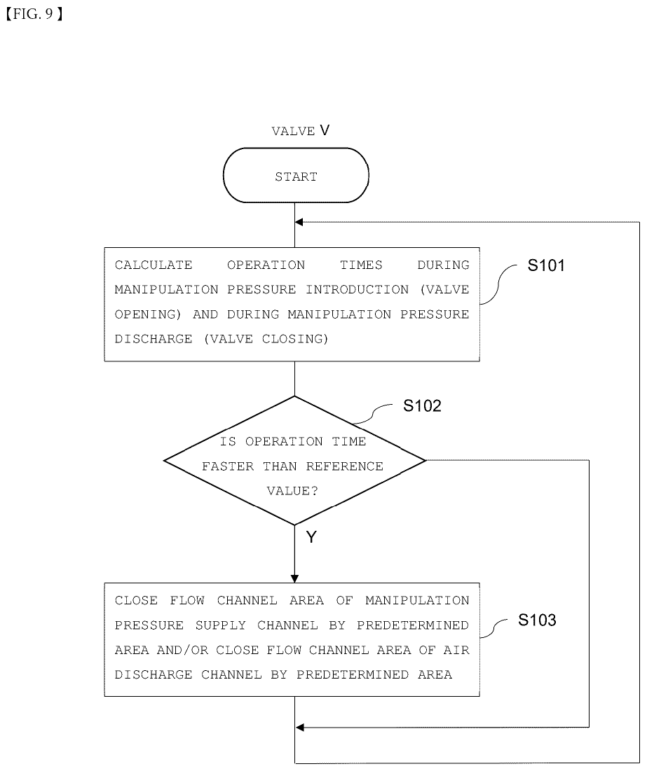

Control based on a result of determination processing performed by the operation time determining unit 71 will be described with reference to FIG. 9.

FIG. 9 illustrates a flow of processing of adjusting the operation time for the valve opening operation.

The operation time determining unit 71 calculates the operation times in the valve opening operation and the valve closing operation from the changes in outputs of the manipulation pressure sensor D and the magnetic sensor M (S101), and then determines whether both the operation times fall within the allowable range compared with the predetermined reference value (S102).

As a result of the determination, when the operation time is out of the allowable range, that is, in a case where the operation time is faster than the reference value, the control unit 70 closes and narrows the flow channel area of the manipulation pressure introduction channel 511 by a predetermined area by the manipulation pressure adjusting mechanism 56 (S103). In the control performed by the control unit 70, the exhaust pressure adjusting mechanism 57 may be controlled instead of or in combination with the adjustment performed by the manipulation pressure adjusting mechanism 56. In this case, the exhaust pressure adjusting mechanism 57 closes and narrows the flow channel area of the air discharge channel 551 by a predetermined area.

In one example, the control of the manipulation pressure adjusting mechanism 56 and/or the exhaust pressure adjusting mechanism 57 is executed in an operation in which a change in the operation time is larger between the valve opening operation and the valve closing operation. For example, in a case where a change in the operation time in the valve opening operation is larger than a change in the operation time in the valve closing operation, the difference in the operation time occurring in the valve opening operation is adjusted by the manipulation pressure adjusting mechanism 56 and/or the exhaust pressure adjusting mechanism 57 at the time of the valve opening operation.

Since the drive fluid is supplied from the drive fluid supply source at constant pressure, a rise rate of the manipulation pressure in the manipulation pressure chamber 52 is decreased by narrowing the flow channel area of the manipulation pressure introduction channel 511, and as a result, the operation time is delayed so that the valve V is open at a normal timing. Similarly, in the air discharge channel 551, the air discharge speed in the atmosphere chamber 55 is decreased by narrowing the flow channel area, and as a result, the operation time is delayed. Consequently, the change in the valve opening time of the valve V due to the change in the operation time is corrected, and the amount of process gas which is the designated amount can be circulated.

The area of the manipulation pressure introduction channel 511 narrowed by the manipulation pressure adjusting mechanism 56 or the area of the air discharge channel 551 narrowed by the exhaust pressure adjusting mechanism 57 is determined by multiplying a predetermined coefficient or based on a numerical value associated with a predetermined table in advance, according to the amount of change from the normal operation time.

In another example, contrary to the one example described above, the manipulation pressure adjusting mechanism 56 and/or the exhaust pressure adjusting mechanism 57 can adjust a change in operation time in an operation in which the change in operation time is smaller between the valve opening operation and the valve closing operation.

Also, the changes in the operation times of both the valve opening operation and the valve closing operation can be offset, and a difference in either the valve opening operation or the valve closing operation can be adjusted by the manipulation pressure adjusting mechanism 56 and/or the exhaust pressure adjusting mechanism 57.

Also, in still another example, in both the valve opening operation and the valve closing operation, changes operation times can be individually adjusted by the manipulation pressure adjusting mechanism 56 and/or the exhaust pressure adjusting mechanism 57.

According to the valve V of the present embodiment described above, the change in operation time due to a change or the like of the valve actuator with the passage of time can be monitored by the valve alone. Also, the flow channel area of the manipulation pressure introduction channel 511 and/or the air discharge channel 551 is adjusted based on the change in the operation time. Consequently, the operation time can be set to an appropriate speed.

In the example in FIG. 9, the manipulation pressure adjusting mechanism 56 and/or the exhaust pressure adjusting mechanism 57 are controlled to adjust the operation time based on the result of the determination processing executed by the operation time determining unit 71. However, the present invention is not limited thereto, and the manipulation pressure adjusting mechanism 56 and/or the exhaust pressure adjusting mechanism 57 can be controlled to adjust the operation time according to any operation performed by an administrator or the like.

Also, the operation time of the valve V in response to the control signal tends to be increased mainly due to the aging such as wear of the O-ring 02, but as the aging further progresses, the operation time tends to be delayed due to progress of leakage in the actuator unit 5 or the like. Therefore, it is also possible to monitor the change in the operation time and detect the timing at which the operation time starts to be delayed to determine abnormality of the valve V.

### REFERENCE SIGNS LIST

1 Valve body portion
11 Base portion
12 cylindrical portion
12a Recess
13 Seat
2 First bonnet portion
21 First bonnet body
21a Through-hole
21b Slit
22 Diaphragm
23 Disk
24 Sensor bonnet
25 Diaphragm presser
26 Presser adapter
4 Second bonnet portion
41 Second bonnet body
43 Stem
431 Rod
44 Spring
5 Actuator unit
51 Supply port
511 Manipulation pressure introduction channel
52 Manipulation pressure chamber
53 Communication hole
54 Piston
55 Atmosphere chamber
551 Air discharge channel
56 Manipulation pressure adjusting mechanism
57 Exhaust pressure adjusting mechanism
58 Isolation wall
60 Flexible cable
70 Control unit
71 Operation time determining unit
72 Communication processing unit
80 Server
81 Operation time determining unit
D Manipulation pressure sensor
M Magnetic sensor (position sensor)
O1, O2 O-ring
VP Pressure sensor
VT Temperature sensor
V Valve

1. A valve comprising:
a manipulation pressure chamber into which a manipulation pressure for opening and closing the valve is introduced;
a manipulation pressure sensor that detects a change in manipulation pressure in the manipulation pressure chamber; and
a position sensor that detects an internal operation of the valve corresponding to the change in manipulation pressure,
wherein a time from a predetermined time point at which the manipulation pressure changes to a predetermined time point at which an operation corresponding to the manipulation pressure is detected by the position sensor, is monitored as an operation time of the valve based on data detected by the position sensor and the manipulation pressure sensor.

2. The valve according to claim 1, further comprising
a manipulation pressure adjusting mechanism that adjusts a flow channel area of manipulation pressure introduction channel communicating with the manipulation pressure chamber based on a difference between the operation time and a predetermined reference value in a case where a change in the operation time is detected.

3. The valve according to claim 1 or 2, further comprising:
an atmosphere chamber that communicates with outside and suctions and exhausts air depending on introduction of the manipulation pressure into the manipulation pressure chamber and discharge of the manipulation pressure from the manipulation pressure chamber; and
an exhaust pressure adjusting mechanism that adjusts a flow channel area of an air discharge channel allowing communication from the atmosphere chamber to the outside based on the difference between the operation time and the predetermined reference value in a case where the change in the operation time is detected.
